(19) United States
(12) Patent Application Publication
(10) Pub. No.: US 2017/0065968 A1
(43) Pub. Date: Mar. 9, 2017

(54) PROCESS TO OBTAIN HYDROGEN PEROXIDE, AND CATALYST AND CATALYSTS SUPPORTS FOR SAID PROCESS

(71) Applicant: SOLVAY SA, Brussels (BE)

(72) Inventors: Frédérique DESMEDT, Brussels (BE); Pierre MIQUEL, Roubaix (FR); Paul DESCHRIJVER, Lennik (BE); Yves VLASSELAER, Leefdaal (BE); Olivier MARION, Lévis (CA); François BELAND, L'Ancienne-Lorette (CA)

(21) Appl. No.: 15/120,061

(22) PCT Filed: Feb. 16, 2015
(86) PCT No.: PCT/EP2015/053220

§ 371 Date: Aug. 18, 2016

(30) Foreign Application Priority Data
Feb. 21, 2014 (EP) 14156077.1

(51) Int. Cl. B01J 31/02; B01J 35/00; C07F 7/08; B01J 37/00; B01J 37/18; C01B 15/029; B01J 23/44; B01J 37/04

(52) U.S. Cl. CPC B01J 31/0275; B01J 23/44; B01J 35/0006; B01J 37/04; B01J 37/009; B01J 37/18; C01B 15/029; C07F 7/0818

(57) ABSTRACT

Catalyst support comprising a material functionalized with at least one acid group and at least one linear hydrophobic group. Catalyst comprising said support and process for the direct synthesis of hydrogen peroxide using said catalyst.

This application claims priority to EP application No. EP 14156077.1 filed on Feb. 21, 2014, the whole content of this application being incorporated herein by reference for all purposes.

This invention is related to a process to obtain hydrogen peroxide by means of the direct reaction of hydrogen and oxygen in the presence of a solvent and a catalyst, and to catalysts and catalysts supports for said process.

Hydrogen peroxide is a highly important commercial product widely used as a bleaching agent in the textile or paper manufacturing industry, a disinfecting agent and basic product in the chemical industry and in the peroxide compound production reactions (sodium perborate, sodium percarbonate, metallic peroxides or percarboxyl acids), oxidation (amine oxide manufacture), epoxidation and hydroxylation (plasticizing and stabilizing agent manufacture). It is used for cleaning surfaces in the semiconductor industry, chemical polishing of copper, brass and other copper alloy surfaces, the engraving of electronic circuits, etc.

The industrial method currently most used for producing hydrogen peroxide is the self-oxidation of alkylanthrahydroquinones. This process, which consists of a number of reduction, oxidation, extraction, purification and concentration stages, is highly complex, thus resulting in the investment and variable costs being quite high.

One highly attractive alternative to this process is the production of hydrogen peroxide directly by reacting hydrogen and oxygen in the presence of metal catalysts from the platinum group. However, in these processes, presence of H⁺ and Br⁻ ions is required in the reaction medium in order to obtain high concentrations of hydrogen peroxide. These ions are obtained from strong acids, such as sulfuric, phosphoric, hydrochloric or nitric acids and inorganic bromides. But working with solutions having a high acid concentration requires the use of special equipment to resist the corrosion. Apart from the above, the presence of acid solutions and halogenated ions favors the dissolution of the active metals (platinum group), which results, first of all, in the deactivation of the catalyst and, due to the concentration of dissolved metals being very low, the recovery thereof becomes unfeasible.

To prevent these drawbacks, alternative processes without the presence of halide ions and/or acids in the reaction medium have been proposed.

In U.S. 2008/299034, catalysts based on silica grafted with p-toluene sulfonic groups are described for the direct synthesis of H2O2 from hydrogen and oxygen. These catalysts show a good activity and a high initial selectivity; however, this selectivity is not stable and decreases when the H2O2 concentration increases. The selectivity evolves in average between 60 and 50% during a test which produces +/−10% Wt H2O2.

The same trend is observed with the catalysts described in WO 2013/010835 which are based on silica grafted with an acid and a brominated group. Here also the activity and the initial selectivity are good but the selectivity is rather unstable and decreases somewhat when the hydrogen peroxide concentration increases.

A method developed to enhance the selectivity is a partial reduction of the catalyst as described in WO 2013/037697. However, it is a real challenge to obtain the good ratio ionic Pd/Pd0.

The innovative solution developed here is the introduction of a linear hydrophobic group on the carrier by covalent bonding. This group makes the catalyst surface hydrophobic and without willing to be bound by a theory, we believe that this decreases the over-hydrogenation of the hydrogen peroxide, while providing a better and more stable selectivity to the catalyst, even at high concentration in hydrogen peroxide.

It is worth noting in that regard that the idea of rendering the surface hydrophobic per se is not new: see namely “Some insights on the negative effect played by silylation of functionalized commercial silica in the direct synthesis of hydrogen peroxide”, Catalysis Today, Volume 158, Issues 1-2, 5 Dec. 2010, Pages 97-102. In this article however, branched hydrophobic groups are used, which sterically hinder the catalyst surface to some extent. Besides, organofluorinated compounds were used which could interact with the noble metal on the catalyst surface. Finally, these hydrophobic groups were grafted to the surface of the support already bearing the acid functions so that these reacted with the hydrophobic groups precursors and that acidity was lost or at least strongly diminished.

It is also worth noting that some commercially available functionalized silica gels namely under the brand SiliaBond® from the company SiliCycle do comprise both acid functions like carboxylic acid, propylsulfonic acid and tosic acid, and hydrophobic groups like TMS or trimethysilyl which are used to end-cap the residual OH groups of the silica gel in order to make it more compatible with polar solvents including methanol.

We have now found that provided linear hydrophobic groups are used, an enhancement in selectivity can be obtained. This innovative solution could be applied to catalyst supports containing only the acid groups as well as to catalyst supports containing both acid and halogenated (like brominated) groups. In the first case, the catalyst support developed is bifunctionalized support, in the second case, it is trifunctionalized support.

The present invention therefore relates to a catalyst support comprising a material simultaneously functionalized with at least one acid group and at least one linear hydrophobic group. In particular, it relates to a catalyst support for direct synthesis of hydrogen peroxide, and a supported catalyst comprising a catalyst and the catalyst support according to the invention. The present invention is also directed to a process for producing hydrogen peroxide, comprising reacting hydrogen and oxygen in the presence of the supported catalyst according to the invention, optionally with the addition of an inert gas, in a reactor.

The expression “catalyst support” intends to denote the material, usually a solid with a high specific surface area, to which a catalyst is affixed and the catalyst support may be inert or participate in the catalytic reactions.

The expression “functionalized with” intends to denote a covalent bond between the material and at least one acid group and at least one linear hydrophobic group. Due to the covalent bonding of the linear hydrophobic group to the material of the catalyst support, the surface of said material becomes hydrophobic which as explained above probably decreases the over-hydrogenation of the hydrogen peroxide, while providing a better and more stable selectivity to the catalyst, even at high concentration in hydrogen peroxide. On the other hand, due to the covalent bonding of the acid group and eventually, of the halogenated group to the material of the catalyst support, any leaching of these functional groups in liquid phase during hydrogen peroxide synthesis is avoided.

According to the present invention, the functional groups are introduced via functionalized silane molecules which bear the corresponding functional groups. By “silane” is meant a monomeric silicon chemical with four substituents attached to the silicon atom. According to the invention, the Si atoms of the silane molecules have 3 substituents which have reacted with the surface of the material to provide the grafting of the silane molecules on the support; and a fourth substituent which is an organic substituent which bears the acid group or which is the linear hydrophobic group.

As acid groups sulfonic, phosphoric, carboxylic and dicarboxylic acid groups can be exemplified, such as p-toluene sulfonic (or tosic acid) groups, which are preferred.

By “linear hydrophobic group” is meant a linear C—C chain substituted with non polar atoms (typically hydrogen only). As linear hydrophobic groups, alkanes are preferred. These alkanes may contain from 1 to 20 C atoms, preferably from 1 to 18 C atoms, more preferably from 2 to 10 C atmos. Butyl or Octyl groups are preferred.

When the material is also grafted with a halogenated group, said group is preferably a halogenophenyl group or halogenopropyl group, in particular a bromophenyl or bromopropyl group, the latter being preferred.

Preferably, the Si atoms of the starting silane molecules (i.e. before they are grafted on the material) bear 3 substituents which are chosen from halogen atoms (preferably C1) and methoxy groups.

In one embodiment, the simultaneously functionalized material used as support can be an organic resin. Preferably, the resins used in the preparation of the catalyst are produced by homopolymerization of monomers or copolymerization of two or more monomers. Examples of resins suitable as a support in the present invention include olefin polymers such as styrenic, acrylic, methacrylic polymers, their copolymers with divinylbenzene, and mixtures thereof, most preferably styrene-divinylbenzene copolymers. These resins are preferably funetionalized with at least one acid group such as sulfonic, carboxylic, dicarboxylic, etc. (Encyclopedia of Chemical Technology Kirk Othmer 3^{rd} Edition, Vol. 13, p 678-705, Wiley-Interscience, John Wiley and Sons, 1981). Furthermore the resins used in the present invention can have an inorganic part, e. g. the resin deposited onto an inorganic solid. Brominated styrene-divinylbenzene copolymers are preferred adsorbing resins for use as the catalyst carrier according to this embodiment of the invention, and brominated styrene-divinylbenzene copolymers having sulfonic acid groups which function as ion exchange radicals are also preferred.

In another embodiment, the catalyst support according to the invention comprises an inorganic solid functionalized with the above mentioned groups. The inorganic solids, which are in most cases inorganic oxides, generally have a large specific surface area. This specific surface area is determined by the ISO 9277:2010 standard method. Usually, the specific surface area is equal to or greater than 20 m²/g, and in particular equal to or greater than 100 m²/g. The inorganic solids often have a pore volume (determined by ISO 15901-2:2006 standard method) of at least 0.1 mL/g, for instance of at least 0.3 mL/g, in particular of at least 0.4 mL/g. The pore volume is in general at most 3 mL/g, most often at most 2 mL/g, for instance at most 1.5 mL/g Pore volumes of 0.1-3 mL/g are suitable and those of 0.4-3 mL/g are preferred.

The most appropriate inorganic solids for this invention are the oxides of the elements of groups 2-14 of the Periodic Table of the elements according to the IUPAC. The oxides most employed can be selected from the group comprised of SiO₂, Al₂O₃, zeolites, B₂O₃, GeO₂, ZrO₂, TiO₂, MgO, CeO₂, ZrO₂, Nb₂O₅, Ta₂O₅ and any mixtures thereof.

Preferably, the functionalized material is a metal oxide chosen from silica, alumina, aluminosilicates, and titanosilicates.

The inorganic material most preferred in this invention is silicon oxide (also called silica) or the mixtures thereof with other inorganic oxides. These materials can essentially have an amorphous structure like a silica gel or can be comprised of an orderly structure of mesopores, such as, for example, of types including MCM-41, MCM-48, SBA-15, among others or a crystalline structure, like a zeolite. These inorganic materials functionalized with acid groups are commercially available and well known for their use as stationary phase of HPLC columns.

Functional groups are incorporated into the inorganic materials of the present invention, bonded to their surface. The groups can be incorporated either during the preparation of the same material or in a process sub-sequent to its preparation, the latter being preferred. The acid group (e.g. p-toluene sulfonic or tosic group), the linear hydrophobic group and eventually a halogenated group (e.g. part of a bromophenyl or bromopropyl group) are covalently bonded to the surface of the inorganic solid, in particular the oxide, for example by silanol functions to a silica surface.

As explained above, it is important that the way the catalyst support is synthesized allows all functions (acid groups, linear hydrophobic groups and eventually halogenated groups) to be present on its surface. Therefore, in a preferred embodiment, the catalyst support according to the invention is synthesized by first grafting the linear hydrophobic groups and the halogen groups, the case being, on the material and only afterwards, the acid groups in order to ensure they remain present on the support. Preferably, the acid groups are obtained through a precursor thereof, for instance a salt (like a chloride) that is afterwards hydrolyzed in the corresponding acid. In a preferred embodiment, the support is silica and the functional groups are grafted on the silanol functions present at its surface. Preferably, in this embodiment, all functional groups are introduced via functionalized chlorosilanes which bear the corresponding functional groups, or via methoxysilanes as far as the halogenated groups are concerned.

In a preferred embodiment of the invention, the catalyst support comprises silica which is grafted with butyl groups and tosic acid groups and preferably also with propylbromide groups. Even more preferably, at least part of its residual OH groups (i.e. the silanol groups which have not reacted through grafting), if any, are end-capped with a branched molecules like TMSCl (trimethylsililchloride or trimethylchlorosilane).

The present invention also concerns a catalyst comprising an element selected from groups 7 to 11 of the Periodic Table or a combination of at least two of them supported on a material simultaneously functionalized with acid groups and linear hydrophobic groups. The element is preferably selected from the group of metals consisting of palladium, platinum, silver, gold, rhodium, iridium, ruthenium, osmium, and mixtures thereof. The most preferred metal is palladium, optionally in combination with another element cited, i.e., a palladium alloy. The amount of metal supported can vary in a broad range, but be preferably comprised between 0.001 and 10% by weight with respect to the weight of the support, more preferably between 0.1 and 5% by weight. The addition of the metal to the support can be performed using any of the known preparation techniques of supported metal catalyst, e.g. impregnation, adsorption, ionic exchange, etc. For the addition of the metal to the support, it is possible to use any kind of inorganic or organic salt or the metal to be added that is soluble in the solvent used in addition to the metal. Suitable salts are for example acetate, nitrate, halide, oxalate, etc.

In a last embodiment, a process for producing hydrogen peroxide, comprising: reacting hydrogen and oxygen in the presence of the supported catalyst according to the invention, optionally with the addition of an inert gas, in a reactor, is provided. The process of this invention can be carried out in continuous, semi-continuous or discontinuous mode, by conventional methods, for example, in a stirred tank reactor with the catalyst particles in suspension, in a basket-type stirred tank reactor, trickled bed, etc. Once the reaction has reached the desired conversion levels, the catalyst can be separated by different known processes, such as, for example, by filtration if the catalyst in suspension is used, which would afford the possibility of its subsequent reuse. In this case, the amount of catalyst used is that necessary to obtain a concentration of H2O2 of 0.01% to 15% by weight regarding the solvent and preferably being 0.1% to 10% by weight.

In the process of the invention, hydrogen and oxygen (as purified oxygen or air) are reacted continuously over a catalyst in the presence of a liquid medium in a reactor to generate a liquid solution of hydrogen peroxide. Hydrogen peroxide formation is carried out by means of a direct reaction between hydrogen and oxygen within a solvent in the presence of a catalyst and, optionally, with the addition of an inert gas. Nitrogen, carbon dioxide, helium, argon, etc. can be used as inert gases. The working pressure is normally above atmospheric pressure, and preferably between 1 and 30 MPa. The molar ratio between hydrogen and oxygen ranges from 1/1 to 1/100. The hydrogen concentration in the gas-phase in contact with the reaction medium should preferably be below 4.16% molar, to maintain the operation outside the explosivity limits of the hydrogen and oxygen mixtures.

The reaction of oxygen with hydrogen is performed at temperatures ranging from −10° C. to 100° C., preferably from 0° C. to 75° C., more preferably from 0° C. to 50° C.

The liquid medium may be water, or it may be a suitable organic solvent such as alcohols or mixtures thereof Suitable organic solvents can include various alcohols, aromatics, and esters, or any other organic compounds that are inert in reaction conditions. Solvents are preferably water-soluble alcohols such as methanol, ethanol, n-propanol, isopropanol, tert-butanol, isobutanol and mixtures thereof. Good results have been obtained with methanol.

In a special embodiment, it might be advantageous to add HBr to the solvent if there is no halogenated group grafted at the surface of the carrier.

In this invention, a hydrogen peroxide-stabilizing agent can also be added to the reaction medium. Some of the hydrogen peroxide-stabilizing agents of which mention can be made are inorganic acids such as: phosphoric acid, sulfuric acid, nitric acid, etc.; organic acids such as: aminomethylenephosphoric acid, etc.; amino acids such as: leucine, etc.; phosphoric acid salts such as: sodium pyrophosphate, etc.; chelating agents such as EDTA, etc.; tension-active agents such as: alkylbenzylsulfonates, etc. These stabilizing agents can be used individually or in combinations of several of them. The preferred stabilizing agents in this invention are aminomethylenephosphoric acid, 1-hydroxyethylene-1,1-diphosphoric acid, ethylene diamine-tetramethylene phosphoric acid, the sodium salts of these compounds and sodium pyrophosphate. The stabilizing agent concentration depends on the type of stabilizing agent and on the concentration of hydrogen peroxide. However, it is preferable to keep the concentration of stabilizing agent low enough to prevent the dissolving of the metal in the catalyst and/or the corrosion of the reactor used. In general, the amount of stabilizing agent added is less than 5000 ppm in relation to the solvent and is preferably less than 500 ppm.

Should the disclosure of any patents, patent applications, and publications which are incorporated herein by reference conflict with the description of the present application to the extent that it may render a term unclear, the present description shall take precedence.

The present invention will now be illustrated in a non limitative way by the following Examples.

### EXAMPLE 1

### Synthesis of Catalysts Supports

Catalyst supports were synthesized for catalysts 1 to 8 (which are according to the invention) and catalysts X and Y (which are not according to the invention) using the following methods:

### Catalyst 1: Support Preparation

### SiliaBond® C1/Tosic acid (47% C1)

In a 500 mL three necks round bottomed flask equipped with a mechanical stirrer and fitted with a condenser, the silica gel (50 g) was placed in toluene (200 mL). To this mixture was added Trichloromethylsilane (2.55 g) and the reaction was stirred at 90° C. for 16 h. The silica was then filtered on Buchner and washed with toluene and methanol. The gel was dried under vacuum at room temperature for 16 h and at 65° C. for 1 h to yield the C1 gel as a white solid (Wt % C=2.94).

In a 500 mL three necks round bottomed flask equipped with a mechanical stirrer and fitted with a condenser, the C1 silica gel (50 g) was placed in dichloromethane (200 mL). To this mixture was added 2-(4-chlorosulfonylphenyl)-ethyltrichlorosilane (50% in toluene; 68 g) and the reaction was stirred at room temperature for 16 h. Trimethylchlorosilane (TMSCl—5.66 g) was added to the reaction and the mixture was stirred at room temperature for an additional 2 h. The silica was filtered on Buchner and washed with dichloromethane and acetone. The gel was dried in vacuum at room temperature for 16 h and at 65° C. for 1 h to yield the C1/Tonsil chloride gel as a white solid (Wt % C=10.31; Wt % S=3.02).

In a 500 mL three necks round bottomed flask equipped with a mechanical stirrer and fitted with a condenser, the C1/Tonsil chloride gel (50 g) was placed in a mixture of water (150 mL) and acetone (150 mL). The reaction was stirred at 35° C. for 16 h. The silica was filtered on Buchner and washed with methanol. The gel was put in an 8/2 mixture (in volume) of methanol and water (300 mL) and stirred for 10 minutes at room temperature. The silica was filtered on Buchner and dried in vacuo at room temperature for 16 h and at at 65° C. for 1 h to yield the C1/Tosic acid gel as a white solid (Wt % C=7.01; Wt % S=1.77).

### Catalyst 2: Support Preparation

### SiliaBond® C4/Tosic Acid (46% C4)

In a 500 mL three necks round bottomed flask equipped with a mechanical stirrer and fitted with a Dean-Stark condenser, the silica gel (50 g) was placed in toluene (250 mL) under an argon atmosphere. The mixture was refluxed to remove 50 mL of toluene/water via the Dean-Stark. The reaction was cooled to room temperature and pyrazine (2.97 g) and n-Butyltrichlorosilane (4.48 g) were added to the mixture. The reaction was stirred under an argon atmosphere at 60° C. for 16 h. The silica was then filtered on Buchner and washed with methanol, toluene and a second portion of methanol. The gel was put in an 8/2 mixture (in volume) of methanol and water (300 mL) and the mixture was stirred for 1 h at room temperature. The gel was filtered on Buchner, washed with methanol and dried in vacuum at room temperature for 16 h and at 65° C. for 1 h to yield the C4 gel as a white solid (Wt % C=2.69).

In a 500 mL three necks round bottomed flask equipped with a mechanical stirrer and fitted with a condenser, the C4 silica gel (50 g) was placed in dichloromethane (200 mL). To this mixture was added 2-(4-chlorosulfonylphenyl)-ethyltrichlorosilane (50% in toluene; 68 g) and the reaction was stirred at room temperature for 16 h. Trimethylchlorosilane (TMSCl—5.66 g) was added to the reaction and the mixture was stirred at room temperature for an additional 2 h. The silica was filtered on Buchner and washed with dichloromethane and acetone. The gel was dried in vacuum at room temperature for 16 h and at 65° C. for 1 h to yield the C4/Tonsil chloride gel as a white solid (Wt % C=10.13; Wt % S=2.25).

In a 500 mL three necks round bottomed flask equipped with a mechanical stirrer and fitted with a condenser, the C4/Tonsil chloride gel (50 g) was placed in a mixture of water (150 mL) and acetone (150 mL). The reaction was stirred at 35° C. for 16 h. The silica was filtered on Buchner and washed with methanol. The gel was put in an 8/2 mixture (in volume) of methanol and water (300 mL) and stirred for 10 minutes at room temperature. The silica was filtered on Buchner and dried in vacuum at room temperature for 16 h and at at 65° C. for 1 h to yield the C4/Tosic acid gel as a white solid (Wt % C=8.17;Wt % S=1.89).

### Catalyst 3: Support Preparation

### SiliaBond® C8/Tosic Acid (47% C8)

Catalyst 3 support was prepared according to the procedure for catalyst 2 support. n-Octyltrichlorosilane (5.79 g) was used in the preparation of the C8 gel. C8/Tosic acid gel was obtained as a white solid (Wt % C=9.04; Wt % S=1.41).

### Catalyst 4: Support Preparation

### SiliaBond® C18/Tosic Acid (48% C18)

Catalyst 4 support was prepared according to the procedure for catalyst 2 support. n-Octadecyltrichlorosilane (9.07 g) was used in the preparation of the C18 gel. C18/Tosic acid gel was obtained as a white solid (Wt % C=12.55; Wt % S=1.20).

### Catalyst 5: Support Preparation

### Trifunctionalized Grafted 8% Propylbromide 17% C4/Tosic Acid

In a 500 mL three necks round bottomed flask equipped with a mechanical stirrer and fitted with a Dean-Stark condenser, the silica gel (50 g) was placed in toluene (250 mL) under an argon atmosphere. The mixture was refluxed to remove 50 mL of toluene/water via the Dean-Stark. The reaction was cooled to room temperature and pyrazine (0.375 g) and n-butyltrichlorosilane (0.5 g) were added to the mixture. The reaction was stirred under an argon atmosphere at 60° C. for 16 h. The silica was then filtered on Buchner and washed with methanol, toluene and a second portion of methanol. The gel was put in an 8/2 mixture (in volume) of methanol and water (300 mL) and the mixture was stirred for 1 h at room temperature. The gel was filtered on Buchner, washed with methanol and dried in vacuum at room temperature for 16 h and at 65° C. for 1 h to yield the C4 gel as a white solid (Wt % C=0.67).

In a 500 mL three necks round bottomed flask equipped with a mechanical stirrer and fitted with a condenser, the C4 silica gel (50 g) was placed in toluene (300 mL). To this mixture was added (3-Bromopropyl)-trimethoxysilane (0.6 g) and the reaction was stirred at 90° C. for 16 h. The silica was then filtered on Buchner and washed with toluene and methanol. The gel was put in methanol (300 mL) and the mixture was stirred for 1 h at room temperature. The gel was filtered on Buchner, washed with methanol and dried in vacuum at room temperature for 16 h and at 65° C. for 1 h to yield the Propylbromide/C4 gel as a white solid (Wt % C=3.36).

In a 500 mL three necks round bottomed flask equipped with a mechanical stirrer and fitted with a condenser, the Propylbromide/C4 silica gel (50 g) was placed in dichloromethane (200 mL). To this mixture was added 2-(4-chlorosulfonylphenyl)-ethyltrichlorosilane (50% in toluene; 68 g) and the reaction was stirred at room temperature for 16 h. Trimethylchlorosilane (TMSCl—5.66 g) was added to the reaction and the mixture was stirred at room temperature for an additional 2 h. The silica was filtered on Buchner and washed with dichloromethane and acetone. The gel was dried in vacuo at room temperature for 16 h and at 65° C. for 1 h to yield the Propylbromide/C4/Tonsil chloride gel as a white solid (Wt % C=12.16; Wt % S=3.51).

In a 500 mL three necks round bottomed flask equipped with a mechanical stirrer and fitted with a condenser, the Propylbromide/C4/Tonsil chloride gel (50 g) was placed in a mixture of water (150 mL) and acetone (150 mL). The reaction was stirred at 35° C. for 16 h. The silica was filtered on Buchner and washed with methanol. The gel was put in an 8/2 mixture of methanol and water (300 mL) and stirred for 10 minutes at room temperature. The silica was filtered on Buchner and dried in vacuum at room temperature for 16 h and at at 65° C. for 1 h to yield the Propylbromide/C4/Tosic acid gel as a white solid (Wt % C=6.89; Wt % S=2.0).

### Catalyst 6: Support Preparation

### Trifunctionalized Grafted 15% Propylbromide 46% C4/Tosic Acid

Catalyst 6 support was prepared according to the procedure for catalyst 5 support. 12 g of n-butyltrichlorosilane were used in the C4 gel preparation. 0.72 g of (3-Bromopropyl)-trimethoxysilane was used in the Propylbromide/C4 gel preparation. Propylbromide /C4/Tosic acid gel was obtained as a white solid (Wt % C=9.06;Wt % S=1.99).

### Catalyst 7: Support Preparation

### Trifunctionalized Grafted 12% Propylbromide 27% C4/Tosic Acid

Catalyst 7 support was prepared according to the procedure for catalyst 5 support. 6 g of n-butyltrichlorosilane were used in the C4 gel preparation. 1.22 g of (3-Bromopropyl)-trimethoxysilane was used in the Propylbromide/C4 gel preparation. Propylbromide/C4/Tosic acid gel was obtained as a white solid (Wt % C=8.70; Wt % S=2.30).

### Catalyst 8: Support Preparation

### Trifunctionalized Grafted 10% Propylbromide 10% C4/Tosic Acid

Catalyst 8 support was prepared according to the procedure for catalyst 5 support. 0.25 g of n-butyltrichlorosilane was used in the C4 gel preparation. 0.60 g of (3-Bromopropyl)-trimethoxysilane was used in the Propylbromide/C4 gel preparation. Propylbromide/C4/Tosic acid gel was obtained as a white solid (Wt % C=9.32; Wt % S=2.86).

The characteristics of these supports figure below namely: their surface area, pore volume and content/nature of linear hydrophobic groups.

### Catalyst 1: SiliaBond® C1/Tosic Acid

47% C1
Surface area: 500 m²/g
Pore volume: 0.8 ml/g

### Catalyst 2: SiliaBond® C4/Tosic Acid

46% C4
Surface area: 500 m²/g
Pore volume: 0.8 ml/g

### Catalyst 3: SiliaBond® C8/Tosic Acid

47% C8
Surface area: 500 m²/g
Pore volume: 0.8 ml/g

### Catalyst 4: SiliaBond® C18/Tosic Acid

48% C18
Surface area: 500 m²/g
Pore volume: 0.8 ml/g

### Catalyst 5: Trifunctionalized Grafted 8% Propylbromide—17% C4

Surface area: 500 m²/g
Pore volume: 0.8 ml/g

### Catalyst 6: Trifunctionalized Grafted 15% Propylbromide—46% C4

Surface area: 500 m²/g
Pore volume: 0.8 ml/g

### Catalyst 7: Trifunctionalized Grafted 12% Propylbromide/27% C4

Surface area: 500 m²/g
Pore volume: 0.8 ml/g

### Catalyst 8: Trifunctionalized Grafted 10% Propylbromide—10% C4

Surface area: 500 m²/g
Pore volume: 0.8 ml/g

### Catalyst X: SiliaBond® Tosic Acid

Surface area: 500 m²/g
Pore volume: 0.8 ml/g

### Catalyst Y: 6% propylbromide/Tosic Acid

Surface area: 500 m²/g
Pore volume: 0.8 ml/g

### EXAMPLE 2

### Catalyst Preparation

20 g of each selected grafted silica was put in a glass reactor of 1 liter equipped with a mechanical stirrer. 600 ml acetone high grade was added to the solid. The suspension was mechanically stirred at room temperature at around 250 rpm. 0.20 g of palladium acetate was dissolved at room temperature in 100 ml of acetone high grade (magnetic stirrer—400 rpm). The Pd solution was added slowly to the suspension (around 1 ml/5 sec). The suspension was maintained under mechanical stirring during 24 hours at room temperature. The suspension was filtered under vacuum and washed with 100 ml acetone high grade. The solid was dried 24 hours at 90° C.

Catalyst X has additionally been reduced during 5 hours under a mixture of hydrogen and nitrogen at 150° C.

The characteristics of the several catalysts are shown in Table 1 below.

Pd concentration has been determined by ICP-OES (Inductively coupled plasma atomic emission spectroscopy). The S and the Br concentrations have been determined by ionic chromatography after mineralization of the samples by Wurzschmitt digestion.

TABLE 1

| | Pd, % Wt | S, % Wt | Br, % Wt |
|---|---|---|---|
| Catalyst 1 | 0.45 | 2.00 | 0 |
| Catalyst 2 | 0.33 | 2.20 | 0 |
| Catalyst 3 | 0.16 | 1.50 | 0 |
| Catalyst 4 | 0.29 | 1.25 | 0 |
| Catalyst 5 | 0.50 | NM | 0.20 |
| Catalyst 6 | 0.09 | NM | 0.78 |
| Catalyst 7 | 0.24 | NM | 0.75 |
| Catalyst 8 | 0.20 | NM | 0.26 |
| Catalyst X | 0.35 | 3.00 | 0 |
| Catalyst Y | 0.43 | 1.57 | 0.43 |

NM = not measured

### EXAMPLE 3

### Direct Synthesis of Hydrogen Peroxide

In a HC-22/250cc reactor, methanol (150 g) and catalyst (3.0 g) were introduced. Eventually, some HBr was added (10 μl of an aqueous solution 12% Wt). The reactor was cooled to 5° C. and the working pressure was set at 50 bars (obtained by introduction of nitrogen). The reactor was flushed during the entire reaction with the following mixture of gases: Hydrogen (3.6% Mol)/Oxygen (55.0% Mol)/Nitrogen (41.4% Mol). The total flow was 2708 mIN/min. When the gas phase coming out of the reactor was stable (measured by GC (Gas Chromatography) on line), the mechanical stirrer was started and set at 1200 rpm. GC on line analyzed every 10 minutes the composition of the gas phase coming out of the reactor. Liquid samples were taken to measure their hydrogen peroxide and water concentration. Hydrogen peroxide concentration was measured by redox titration with cerium sulfate and water concentration was measured according to the Karl-Fisher method.

The experimental conditions used and the results obtained are detailed in Tables 2 to 6 below.

Table 2 shows the selectivity improvement attained through the addition of a C4 linear hydrophobic group to an acid functionalized support.

Table 3 shows the influence of the nature (length) of the hydrophobic group.

Table 4 shows the influence of the reaction temperature.

Table 5 shows the selectivity improvement attained through the addition of a C4 linear hydrophobic group to a bromo and acid functionalized support.

Table 6 shows the influence of the ratio between the different functional groups.

TABLE 2

Catalyst

| | | 2 | X |
|---|---|---|---|
| Methanol | g | 150.1 | 151.63 |
| HBr | ppm | 10 | 9 |
| Catalyst | g | 3.0281 | 2.9799 |
| Temperature | ° C. | 5 | 5 |
| Pressure | bar | 50 | 50 |
| Hydrogen | % Mol | 3.6 | 3.6 |
| Oxygen | % Mol | 55.0 | 55.0 |
| Nitrogen | % mol | 41.4 | 41.4 |
| Total flow | mlN/min | 2708 | 2708 |
| Speed | rpm | 1200 | 1200 |
| Contact time | min | 240 | 240 |
| H₂O₂ fin | % Wt | 10.26 | 10.43 |
| Water fin | % Wt | 4.01 | 4.55 |
| Conversion fin | % | 53.4 | 52.2 |
| Selectivity init | % | 75 | 58 |
| Selectivity fin | % | 58 | 55 |

TABLE 3

| | | Catalyst | | | |
|---|---|---|---|---|---|
| | | 1 | 2 | 3 | 4 |
| Methanol | g | 152.9 | 150.1 | 150.05 | 150.79 |
| HBr | ppm | 10 | 10 | 10 | 10 |
| Catalyst | g | 2.9848 | 3.0281 | 2.9995 | 3.0039 |
| Temperature | ° C. | 40 | 40 | 40 | 40 |
| Pressure | bar | 50 | 50 | 50 | 50 |
| Hydrogen | % Mol | 3.6 | 3.6 | 3.6 | 3.6 |
| Oxygen | % Mol | 55.0 | 55.0 | 55.0 | 55.0 |
| Nitrogen | % mol | 41.4 | 41.4 | 41.4 | 41.4 |
| Total flow | mlN/min | 2708 | 2708 | 2708 | 2708 |
| Speed | rpm | 1200 | 1200 | 1200 | 1200 |
| Contact time | min | 240 | 240 | 240 | 240 |
| H₂O₂ fin | % Wt | 7.14 | 8.50 | 7.72 | 4.28 |
| Water fin | % Wt | 9.44 | 8.57 | 5.93 | 9.99 |
| Conversion | % | 71.5 | 69.10 | 53.20 | 76.10 |
| fin | | | | | |
| Selectivity | % | 48 | 67 | 66 | 58 |
| init | | | | | |
| Selectivity | % | 29 | 35 | 41 | 19 |
| fin | | | | | |

TABLE 4

Catalyst

| | | 2 | 2 |
|---|---|---|---|
| Methanol | g | 150.1 | 150.1 |
| HBr | ppm | 10 | 10 |
| Catalyst | g | 3.0281 | 3.0281 |
| Temperature | ° C. | 40 | 5 |
| Pressure | bar | 50 | 50 |
| Hydrogen | % Mol | 3.6 | 3.6 |
| Oxygen | % Mol | 55.0 | 55.0 |
| Nitrogen | % mol | 41.4 | 41.4 |
| Total flow | mlN/min | 2708 | 2708 |
| Speed | rpm | 1200 | 1200 |
| Contact time | min | 240 | 240 |
| H2O2 fin | % Wt | 8.50 | 10.26 |
| Water fin | % Wt | 8.57 | 4.01 |
| Conversion fin | % | 69.10 | 53.4 |
| Selectivity init | % | 67 | 75 |
| Selectivity fin | % | 35 | 58 |

TABLE 5

Catalyst

| | | 5 | Y |
|---|---|---|---|
| Methanol | g | 150.34 | 150.4 |
| HBr | ppm | / | / |
| Catalyst | g | 3.0058 | 3.026 |
| Temperature | ° C. | 5 | 5 |
| Pressure | bar | 50 | 50 |
| Hydrogen | % Mol | 3.6 | 3.6 |
| Oxygen | % Mol | 55.0 | 55.0 |
| Nitrogen | % mol | 41.4 | 41.4 |
| Total flow | mlN/min | 2708 | 2708 |
| Speed | rpm | 1200 | 1200 |
| Contact time | Min | 240 | 240 |
| Hydrogen peroxide | % Wt | 13.75 | 11.15 |
| fin | | | |
| Water fin | % Wt | 3.33 | 3.04 |
| Conversion fin | % | 60.6 | 60.1 |
| Selectivity init | % | 81 | 66 |
| Selectivity fin | % | 69 | 66 |

TABLE 6

| | | Catalyst | | | |
|---|---|---|---|---|---|
| | | 6 | 7 | 5 | 8 |
| Methanol | g | 150.15 | 151.71 | 150.34 | 149.61 |
| HBr | ppm | / | / | / | / |
| Catalyst | g | 2.9942 | 2.9992 | 3.0058 | 2.9991 |
| Temperature | ° C. | 5 | 5 | 5 | 5 |
| Pressure | bar | 50 | 50 | 50 | 50 |
| Hydrogen | % Mol | 3.6 | 33.6 | 3.6 | 3.6 |
| Oxygen | % Mol | 55.0 | 55.0 | 55.0 | 55.0 |
| Nitrogen | % mol | 41.4 | 41.4 | 41.4 | 41.4 |
| Total flow | mlN/ | 2708 | 2708 | 2708 | 2708 |
| | min | | | | |
| Speed | rpm | 1200 | 1200 | 1200 | 1200 |
| Contact time | min | 240 | 240 | 240 | 240 |
| H₂O₂ fin | % Wt | 3.03 | 5.81 | 13.75 | 8.13 |
| Water fin | % Wt | 0.73 | 1.98 | 3.33 | 3.81 |
| Conversion fin | % | 9.8 | 20.2 | 60.6 | 44.2 |
| Selectivity init | % | 67 | 71 | 81 | 78 |
| Selectivity fin | % | 67 | 64 | 69 | 53 |

1. A catalyst support, comprising a support material having a surface, at least one acid group grafted on the surface, and at least one linear hydrophobic group grafted on the surface, wherein each of the at least one acid group and at least one linear hydrophobic group is part of a respective silane molecule, each of the respective silane molecules comprises a Si atom and four substituents per such Si atom, 3 of the four substituents are covalently bonded to the surface of the support material, the fourth of the four substituents of a respective one of the silane molecules is an organic substituent which comprises the at least one acid group, and the fourth of the four substituents of another of the respective the silane molecules is the at least one linear hydrophobic group.

2. The catalyst support according to claim 1, wherein the acid group is selected from the group consisting of sulfonic, phosphonic, carboxylic, and dicarboxylic acid groups.

3. The catalyst support according to claim 2, wherein the acid group is p-toluene sulfonic acid.

4. The catalyst support according to claim 1, wherein the linear hydrophobic group is an alkane having from 1 to 20 carbon atoms.

5. The catalyst support according to claim 1, wherein the catalyst support further comprises a halogenated group grafted to the surface of the support material, wherein the halogenated group is part of a silane molecule, that comprises a Si atom having four substituents per such Si atom, 3 of such substituents are covalently bonded to surface of the support material, and the fourth of such substituents is the halogenated group.

6. The catalyst support according to claim 1, wherein the respective silane molecules are derived from starting silane molecules that comprise 3 substituents selected from the group consisting of halogen atoms and methoxy groups.

7. The catalyst support according to claim 1, wherein the support material is a metal oxide preferably chosen from silica, alumina, aluminosilicates, and titanosilicates.

8. The catalyst support according to claim 7, wherein the support material is silicon oxide.

9. The catalyst support according to claim 8, wherein the at least one linear hydrophobic group is a butyl group and the at least one acid group is a p-toluene sulfonic acid group.

10. A catalyst comprising an element selected from groups 7 to 11 of the Periodic Table or a combination of at least two of such elements supported on a catalyst support according to claim 1.

11. The catalyst according to claim 10, wherein the element comprises a metal.

12. The catalyst according to claim 11, wherein the metal is present in an amount of between 0.001 and 10% by weight with respect to the weight of the catalyst support.

13. A process for producing hydrogen peroxide, comprising reacting hydrogen and oxygen in presence of the catalyst according to claim 10.

14. The process according to claim 13, wherein the catalyst is present in an amount effective to obtain a concentration of H₂O₂ of 0.01% to 15% by weight with respect to the weight of the solvent.

15. The process according to claim 13, wherein reaction of oxygen with hydrogen is performed at temperatures ranging from 0° C. to 50° C.

16. The catalyst support according to claim 4, wherein the linear hydrophobic group is a butyl group or an octyl group.

17. The catalyst support according to claim 5, wherein the halogenated group is a halogenophenyl group or a halogenopropyl group.

18. The catalyst support according to claim 9, further comprising propylbromide groups grafted on the silica support material.

19. The catalyst support according to claim 9, wherein residual OH groups, if any, of the silica support material are end-capped with branched molecules.

20. The catalyst according to claim 10, wherein the catalyst comprises palladium or an alloy of palladium with another noble metal supported on the catalyst support.
